(19) United States
(12) Patent Application Publication
(10) Pub. No.: US 2005/0236022 A1
(43) Pub. Date: Oct. 27, 2005

(54) Ostomy bag cleaning device

(76) Inventors: Bobby D. Bailiff, Stamford, TX (US); Ruthie Lee Bailiff, Stamford, TX (US)

Correspondence Address: Delphine M. James, Ste. 170, 2656 South Loop West, Houston, TX, 77054, US

(21) Appl. No.: 10/897,391

(22) Filed: Apr. 21, 2004

(51) Int. Cl. B08B 3/00

(52) U.S. Cl. 134/105; 134/174

(57) ABSTRACT

A ostomy cleaning device comprises a relatively small tank having a heating element, an inlet port and an outlet port. The inlet port is coupled to a water supply and the outlet port coupled to a hose attachment. A sprayer nozzle attached to the hose attachment. A pressure regulator is operationally coupled between the water supply and the inlet port for controlling the water pressure from the water supply to a level sufficient to accommodate the hose attachment. A temperature regulator is operationally coupled to the heating element for controlling the temperature of the water contained in the tank to a relatively warm temperature.

### BACKGROUND

The present invention relates to a device for cleaning a ostomy bag worn by an ostomy patient. After a patient has an ostomy operation in which a portion of the intestinal is removed, the body waste is excreted into an attached ostomy bag. When the ostomy bag becomes full, the bag must be cleaned. Since the bag contains human waste, the ostomy bag must be cleaned in a sanitary manner. It is the object of the present invention to provide an apparatus for efficiently cleaning the ostomy bag and discarding the human waste into a sewage facility

### SUMMARY

The present invention provides a device adapted to clean an ostomy bag. The device comprises a relatively small tank having a heating element, an inlet port and an outlet port. The inlet port is coupled to a water supply and the outlet port coupled to a hose attachment. A sprayer nozzle attached to the hose attachment. A pressure regulator is operationally coupled between the water supply and the inlet port for controlling the water pressure from the water supply to a level sufficient to accommodate the hose attachment. A thermostat is operationally coupled to the heating element for controlling the temperature of the water contained in the tank to a relatively warm temperature.

### BRIEF DESCRIPTION OF DRAWINGS

Various other features of the present invention will be better understood when considered in conjunction with the accompanying drawings.

FIG. 1 illustrates a perspective view of the present invention.

FIG. 2 illustrates an exploded view of the heating unit.

FIG. 3 illustrates an exploded external view of the heating unit with the nozzle attachments.

### DETAILED SPECIFICATION

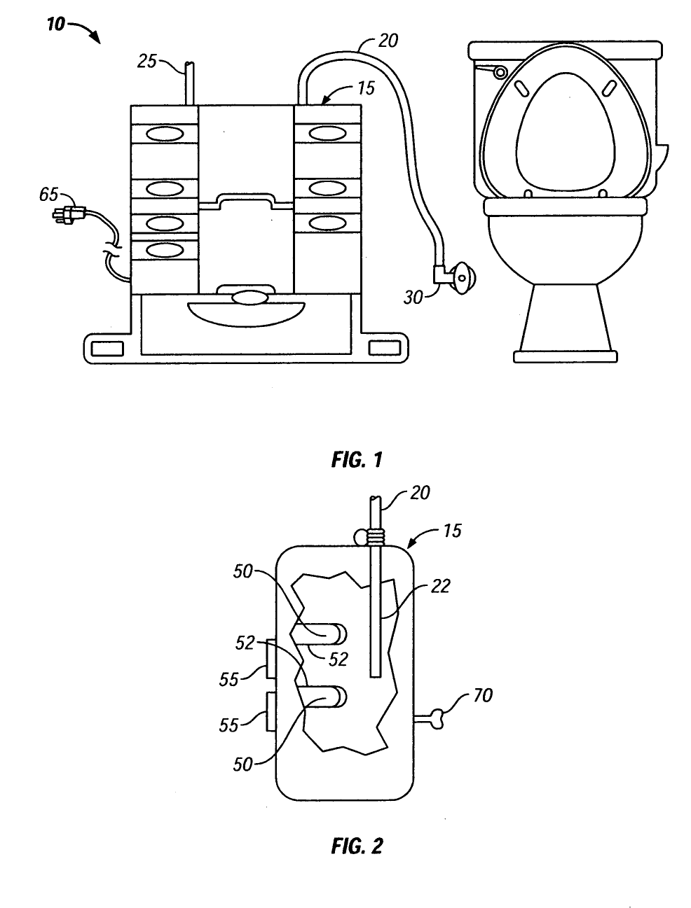

Referring to FIG. 1, there is shown a perspective view of the present invention, a device (10) for cleaning an ostomy bag. Device (10) further comprises a relatively small tank (15) having an inlet port (20) and an outlet port (25). Inlet port (20) is operationally coupled to the house water supply (30) for providing cold water into the tank (15). Generally, device (10) is coupled to the water supply near a toilet. Using device (10) near a toilet allows for sanitary disposal of bodily waste.

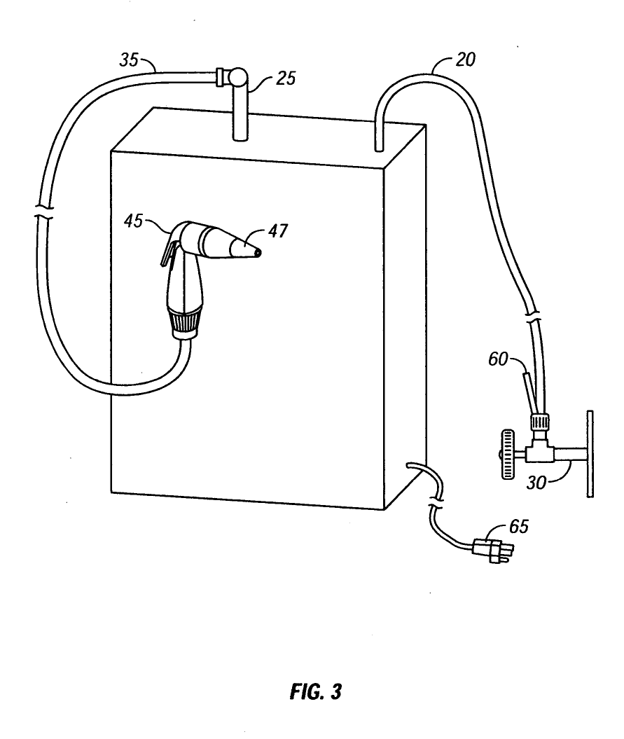

Referring to FIG. 2, there is shown an exploded cross-sectional view of the tank (15). Tank (15) can be a small conventional portable water heater capable of holding at least one gallon of water. Inlet port (20) can be conventional piping with a mechanism for pumping the cold water in tank (15). Inlet port (20) can be coupled to an elongated pipe (22) which extends near the bottom of the tank. Elongated pipe (22) can be a conventional dip tube utilized in water heaters. As cold water is drawn into the bottom of the tank (15), it remains at the bottom because the cold water is denser than hot water. At the lower end of tank (15) is a drain outlet pipe (70) for draining tank (15).

Operationally situated within tank (15) is a heating element (50) for heating the cold water in the tank (15). Heating element (50) can be conventional electric heating coils. The electric coils are immersed in the water of the tank. The tank can have more than one heating element. In some heaters, the heating element can be a gas burner.

Temperature regulator (55) is operationally associated with heating element (50). Temperature regulator (55) can be a conventional thermostat. Thermostat (55) can be operationally installed within the internal wall of the tank. Also, thermostat (55) can be surrounded by insulation material to prevent operational interference by the water within the tank (15). Thermostat (55) controls the temperature of the water in tank (15). When the temperature of the water in tank (15) reaches the set temperature, a heat anticipator automatically shuts heating element (50). When the temperature of the water decreases below the required temperature, a control switch mechanism automatically turns the heating element (50) back on. Each heating element can be associated with a separate thermostat. Additionally, the set temperature of the water in the tank can be adjustable via knob (52).

To prevent injury, the water cannot be scalding hot as conventional water heaters. However, the water must be at a relatively warm temperature for sanitation purposes. A relatively warm temperature of the water in tank (15) can be between 84 and 98 degrees. Thus, thermostat (55) of the present invention is specifically designed not to exceed the required water temperature of tank (15). A conventional portable water heater currently maintains the water temperature between (120 and 140 degrees) which is too hot for the present invention.

As shown in FIG. 3, pressure regulator (60) is operationally coupled between the water supply (30) and the inlet port (20) for controlling the water pressure from the water supply to a level sufficient to accommodate the hose attachment (35). The PSI for a home is normally approximately 50-60 PSI, which is too powerful for the hose attachment (35). Thus, a pressure regulator (60) is required to maintain the pressure at a certain level. The PSI for the hose attachment is generally between 1 and 2 lbs.

Power source (65) is connected to tank (15). Power source (65) can be electrical or battery powered for portability. Some water heaters can be powered by gas. Power source (65) is required for heating element (50) illustrated in FIG. 2.

As depicted in FIG. 3, outlet port (25) is coupled to hose attachment (35) attached to a sprayer nozzle (45). Outlet port (25) can be conventional piping which is attached hose attachment (35) which is connected to nozzle sprayer (45). Cone attachment (47) can be coupled to sprayer (45) for better focusing the water while irrigating the ostomy bag. Cone (47) can be removable from sprayer nozzle (45). As nozzle sprayer (45) uses the warm water in the tank, heated water is drawn from the top of the tank. Additionally, more cold water is drawn into the bottom of the tank through elongated pipe (22) shown in FIG. (2). If the warm water is used faster than heating element (50) can heat the incoming cold water, than tank (15) will run out of warm water.

1. a device for cleaning an ostomy bag, the device comprising:
a relatively small tank having an inlet port and an outlet port;
the inlet port coupled to the house water supply for providing cold water into the tank;
the outlet port coupled to a hose attachment;
at least one heating element operationally situated internally within the tank,
the at least one heating element for heating the water contained within the tank;
a pressure regulator operationally coupled to the water supply for controlling the water pressure from the water supply to a level sufficient to accommodate the hose attachment;
a temperature regulator operationally coupled to the at least one heating element for maintaining the temperature of the water contained in the tank at a predetermined warm temperature;
a sprayer nozzle coupled to the hose attachment for irrigating the ostomy bag as well as the body with the warm water contained in the tank; and
a power source operationally coupled to the tank.

2. The device of claim 1 wherein the power source is electrical.

3. The device of claim 1 wherein the power source is battery.

4. The device of claim 3 wherein the battery is rechargeable.

5. The device of claim 1 wherein the temperature regulator is adjustable.

6. The device of claim 1 wherein the temperature regulator further comprises:
a heat anticipator operationally associated with to heat element such that the at least one heating element turns off when the water reaches the predetermined temperature; and
a control switch mechanism operationally associated with the at least one heating element such that the at least one heating element turns on when the water in the tank reaches the predetermined temperature.

7. The device of claim 1 further comprising:
the tank being defined by a top and a bottom;
an elongated pipe internally situated within the tank extending from the top of the tank to near the bottom of the tank; and
the pipe being coupled to the inlet port.

8. The device of claim 1 wherein the temperature regulator is digital.

9. The device of claim 1 further comprising a cone member attached to the sprayer nozzle.

10. The device of claim 9 wherein the cone member is detachable from the sprayer nozzle.

11. The device of claim 1 further comprising a drain outlet pipe attached to the lower end of the tank.
